(19) United States
(12) Patent Application Publication
(10) Pub. No.: US 2026/0251034 A1
(43) Pub. Date: Aug. 27, 2026

(54) PLUG BARRIER MATERIAL

(71) Applicant: ISOL8 (HOLDINGS) LIMITED, ABERDEEN (GB)

(72) Inventors: Andrew Louden, Aberdeen (GB); William Edward Lowry, Port Townsend, WA (US); Robin Jerman, Port Townsend, WA (US)

(73) Assignee: ISOL8 (HOLDINGS) LIMITED, ABERDEEN (GB)

(21) Appl. No.: 18/994,292

(22) PCT Filed: Jul. 14, 2023
(86) PCT No.: PCT/EP2023/025329

§ 371 Date: Jan. 14, 2025

(30) Foreign Application Priority Data
Jul. 14, 2022 (GB) 2210345.1
Mar. 28, 2023 (GB) 2304549.5

(51) Int. Cl. E21B 33/13; C09K 8/516

(52) U.S. Cl. CPC E21B 33/13; C09K 8/516; C09K 8/426

(57) ABSTRACT

A plug or barrier-forming material comprises a matrix of a first metal (172) and an aggregate of uniform or irregular shaped macroscopic objects (174). The aggregate may comprise steel spheres (174) coated with a second metal (178) to facilitate bonding to the first metal (172).

### FIELD

This disclosure relates to plug or barrier-forming material. The material may have utility in plugging or sealing downhole bores such as those used to access subsurface hydrocarbon-bearing formations. Aspects of the disclosure also relate to delivering, forming, securing, and setting plugs and barriers in downhole bores, and to the composition of such plugs and barriers.

### BACKGROUND

Abandoned oil and gas wells may be sealed or plugged to prevent subsequent release or escape of hydrocarbons or other fluids. Apparatus and methods which may be useful in sealing such wells is described in applicant's earlier publications U.S. Pat. Nos. 9,394,757B2, 9,228,412B2, and 9,494,011B1, the disclosures of which are incorporated herein in their entirety.

The material used to form the plug or seal may comprise a low melting point alloy which is deployed in the well and then heated and fluidised; the molten alloy may then flow to occupy a volume within the well bore. The alloy subsequently cools and solidifies, forming a seal with a surrounding bore wall. A variety of plug-forming materials have been proposed, for example bismuth-tin (Bi—Sn) alloys. However, it has been identified that some of the proposed materials may be brittle, susceptible to creep and adversely affected by aging. The cleanliness of the downhole bore may also have an adverse effect on the ability of the alloy to form a seal.

U.S. Pat. No. 5,223,347 describes composite alloy plugs in which steel or iron shot, or aggregate, is combined with conventional alloys. The matrix alloy may primarily consist of some or all of copper, magnesium, bismuth, tin, lead, cadmium, and indium. The shot has a higher hardness and melt point than the matrix alloy.

WO2020123918 describes thermite-alloy composite plugs for abandoned wells. Agents or additives may be provided to modify the mechanical or thermal properties of the composite.

U.S. Pat. No. 6,923,263B1 discloses an expanding alloy plug with internal reinforcement in its core which causes the alloy to expand preferentially in a radial direction and thus enhance mechanical attachment to surrounding tubing.

U.S. Pat. No. 9,181,775B2 discloses use of a bismuth alloy plug contained between upper and lower fins. The alloy may include particulates in the form of “floating” balls of steel and “sinking” balls of tungsten which move through the molten alloy to occupy gaps between the fins and the surrounding casing.

WO2021260442 discloses an expanding alloy plug with composite reinforced ends and a mostly-bismuth-alloy middle section. The composite comprises a eutectic bismuth alloy and a particulate material of greater strength than the bismuth material.

### SUMMARY

According to an aspect of the present disclosure there provided a plug or barrier-forming material comprising: a matrix of a first metal, and particulate or fibrous material.

An alternative aspect of the present disclosure relates to a plug or barrier-forming material comprising: a matrix of a first metal and an aggregate of uniform or irregular shaped macroscopic objects.

A further aspect of the present disclosure relates to a plug or barrier-forming material comprising a layered combination of a first metal with a reinforcing material placed above the first metal.

For brevity, reference may be made below to particulate material, but this should be understood to encompass the other materials, objects or forms that may be combined with the first metal.

Aspects of the present disclosure also relate to the creation of downhole plugs and barriers using such materials.

The materials may be melted or otherwise fluidised and then solidified to form a plug or barrier.

The plug or barrier-forming material is thus adapted to form a composite or composite structure which may exhibit advantageous properties.

The first metal may be a bismuth-based alloy which expands on solidification against a tubular or other downhole substrate. Alternatively, the first metal may be a low melt-point alloy that does not expand on solidification and is dependent on bonding to the tubular or casing to form a seal. The first metal may comprise any appropriate metal or combination of metals, including bismuth, silver, zinc, copper, magnesium, tin, lead, cadmium, and indium.

In other examples the first metal, or a composite of the first metal and an aggregate, may have a low thermal coefficient of expansion when compared to the material of the tubular or other downhole substrate, for example well casing steel. In forming the plug or barrier, the aggregate, metal, and casing may all be heated up to a uniform elevated temperature to fluidise the metal, then cool down to the ambient well temperature. The resulting temperature change can be on the order of 50 to 400° C. The aggregate may be formed of low COE metals such as invar (a 36% nickel/64% iron by mass alloy), with a linear coefficient of expansion as low as 1e-6/° K as compared to the COE of steel of 10.8e-6/° K. This difference in COE produces the favourable condition of the settled and consolidated aggregate reducing in approximately 1/10^{th} in linear dimension compared to the surrounding steel tubing, effectively locking the composite plug inside the tubular, and further resisting any axial load exerted on the plug.

The plug or barrier-forming material may be deployed in a bore to be plugged or sealed, such as a metal downhole tubular, for example casing or liner. Thus, the plug or barrier-forming material may engage and seal with a surface of the tubular, or indeed some other downhole substrate.

The plug or barrier-forming material may be deployed in any appropriate form, for example as a flowable material adapted to be carried into a bore in a dump bailer or other container, to flow into a location where the plug or barrier is required. Alternatively, the material may be deployed directly to the plug or barrier location, and in such a situation the material need not be flowable or displaceable, for example the material may be cast or may be formed of compacted powder or other material.

The plug or barrier-forming material may be provided in combination with other materials or structures which are located in a bore in sequence to provide a layered plug or barrier. Each layer may perform a distinct role as, for example, sealant, mechanical anchor, or reinforcing element. A top or upper layer may be a ceramic, for example a feldspar such as anorthite. Such upper ceramic layer may be the product of a separate thermite reaction or placed by other means above the alloy barrier.

The first metal may comprise a single metal or may be an alloy. The terms “metal” and “alloy” may be used interchangeably herein, and for example, a reference to “alloy” is not intended to exclude a corresponding method or structure utilising a single metal.

Some aspects of the disclosure relate to apparatus and methods that utilise eutectic alloys, that is alloys that melt and freeze at a single temperature that is lower than the melting points of the separate constituents of the alloy or of any other mixture of them. Other aspects of the disclosure relate to non-eutectic alloys.

The form, size and material of the particulate material may be selected to suit, for example, the deployment method, and the desired characteristics of the resulting composite material. For example, if the material incorporates an aggregate, the aggregate may be in various forms and sizes, for example having a larger dimension of 0.5 mm or more, 1.0 mm or more, or a diameter between 1.5 and 20 mm. In some examples steel aggregate of 1.6 mm or more in diameter may be utilised, for example mild steel balls which may be coated with a material such as zinc, tin, or copper to enhance bonding of the steel to the first metal. The selected size may depend on the clearances in the material deposit or deployment system, for example dump bailer, cast, or powder compaction, and the tubing and annulus dimensions. The form of the aggregate may be spherical or irregular, spherical being preferred if the material is to be dispensed from a bailer or other storage/delivery vessel or if it is otherwise preferable for the material to be mobile or flowable. However, irregular, or angular aggregate may improve the mechanical properties of the resulting composite due to enhanced interlocking.

The aggregate material may be selected based on desired final composite properties. For example. high density, high elastic modulus metals may maximize the strength of the composite. However, lower density, insulating aggregate forms can be used to reduce the thermal conductivity of the composite, resulting in higher composite temperatures during the melting phase in the deployment.

The particulate material may comprise micro or nano particles of metallic, intermetallic, or ceramic material. Such materials may impede or otherwise affect grain growth or microstructural evolution and may reduce creep.

The particulate material may comprise nano tubes or fibres or particles of materials such as carbon, glass, ceramic, metal, or metal oxides. Such materials may act as structural reinforcement. In one example, the particulate material comprises nickel coated carbon nano tubes.

The particulate material may comprise long, low density metal fibres (such as ferroaluminium fibres) anchored to small spheres of high-density material such as tungsten. If the first metal is in a molten or otherwise fluidised form the metal fibres may float upward and form preferentially vertical reinforcements in the barrier-forming material. Such oriented reinforcements may increase the bulk shear strength of the barrier-forming material.

The particulate material may comprise macro scale objects of metal, ceramic, or metal oxides which are encapsulated in the alloy. Such materials may act as aggregate reinforcement, similar to crushed rock or gravel in concrete.

The particulate material may have a uniform spherical shape and may enhance flowability of the plug or barrier-forming material. Such advantages may also be available from particulate materials that are other than a uniform spherical shape, for example an ovoid or oval shape.

The particulate material may have an angular or irregular shape, and this may increase surface area and enhance interlocking amongst aggregate particles or to the surface of downhole tubing or other downhole structures or materials. Particulate material with an angular or irregular shape may be initially coated or encapsulated to form beads or otherwise provide a spherical or substantially smooth shape to enhance flowability. The coatings may comprise an alloy and may also contain bonding agents. The bonding agents may be hermetically encapsulated or coated to maintain integrity in an aqueous environment. The coatings may melt, dissolve, diffuse or decompose upon exposure to high temperatures.

Aggregate particulate materials may form an interlocking structure, bound together by the first metal. The structure may carry any stresses in the plug or barrier and reduce tertiary creep of the first metal, ensuring long term performance. The volume, density and distribution of particulate size may be optimised for different wellbore tubing geometries.

In one example the aggregate material may comprise spring material, compressed into a small or compact form, and cast within metal beads, so that when the beads melt the spring material expands and fills a larger volume, and may interlock with adjacent spring material and form a fully reinforced metal volume. The spring material may take any appropriate form, for example a wire coil, which may have a conical form. Alternative metal structures with a higher melt-point can be cast within the first metal to provide reinforcement upon subsequent solidification of the first metal. The metal structures may be formed of any appropriate metal, for example steel.

The plug or barrier-forming material may comprise a bonding agent, such as a flux, which facilitates bonding the particulate or other material to the first metal. The plug or barrier-forming material may thus form a monolithic composite structure with compressive strength significantly greater than that of the individual ingredients. A bonding agent or flux may also facilitate bonding of the first metal to downhole structures, such as a surrounding tubing.

The particulate material may be coated with a bonding material to facilitate bonding of the particulate material with the first metal. The bonding material may comprise sodium nitrate, copper, nickel, tin, or another intermediate layer material.

The particulate material may comprise small oxide particles, dispersed within the first metal.

The particulate material may comprise nano particles of metal such as silver, nickel, and copper, or ceramics such as aluminium oxide, which may modify the microstructure of the first metal during solidification and crystallization to inhibit crystal growth and reduce long term creep.

The particulate material may comprise nano or micro particles of molybdenum, nickel, and oxides of tin and yttrium. These particles may enhance bonding by altering the surface tension or wetting angle of the first metal against a substrate surface.

The solid-liquid interdiffusion bonding technique based on intermetallics may be used as an additional or alternative bonding medium (See, for example, Intermetallic Compounds-Formation and Applications, Edited by Mahmood Aliofkhazraei, Chapter on “Intermetallic Bonding for High-Temperature Microelectronics and Microsystems: Solid-Liquid Interdiffusion Bonding” by Knut E. Aasmundtveit, Thi-Thuy Luu, Hoang-Vu Nguyen, Andreas Larsson and Torleif A. Tollefsen). This bonding method may deliver improved thermal stability, in that the bond may survive temperatures greater than the initial bonding temperature. One example of such a process is a tin-based solder alloy, with a melt temperature of 250-300° C. When bonded to a material such as copper and held at the bonding temperature for an extended time, the substrate material will diffuse into the alloy and form an intermetallic compound, with a resulting melt temperature much higher than the initial bond temperature (in this case more than 400° C. higher than the bond temperature). This may dramatically improve long term creep performance of the bonded alloy.

The particulate material may be selected to favourably alter the thermal or physical characteristics of the barrier material by altering its thermal conductivity and the energy required to melt the mixture, to facilitate emplacement and barrier formation. For example, using steel balls may significantly increase the thermal conductivity of the composite by a factor of as much as two, and may reduce the energy required to melt the first metal by more than 50%, greatly increasing the rate at which thermal energy can be absorbed by the barrier material and the melting rate of the alloy, and reducing the formation time.

Components of the plug or barrier-forming material, which may include the first metal, aggregate and a bonding material, may be powder compacted separately or combined into a form that can be deployed or deposited into a wellbore from surface by gravity or dispensed from a suitable container deployed in the well. The deployment form may be a spherical ball, a cylinder or another shape that can be easily deployed in a well.

Active alloys may be used in combination with some form of agitation, for example mechanical agitation or vibration, to establish a bond with the neighbouring material, steel tubing or casing, coated tubing, or rock, with or without the presence of a bonding facilitating material, such as flux. Active alloys contain reactive elements such as indium, titanium, hafnium, zirconium, and rare earth elements such as cerium, lanthanum, and lutetium. These additives cause reactions at the interface between the alloy and base metal which reduce the surface tension and improve wetting of the alloy on the substrate metal. Wetting is the process which enables the formation of a metallurgical bond between the alloy and substrate. Mechanical agitation accelerates wetting and may involve the mechanical disturbance of an interface between the alloy and the neighbouring material. Vibration may be delivered by a variety of means including ultrasonics.

Ultrasonic soldering may be used to improve bonding of the molten alloys to neighbouring material. The powering of piezoelectric crystals to generate high frequency acoustic waves between 10 to 60 kHz in the molten alloy may be used to disrupt oxides and facilitate bonding of the alloy to the neighbouring material. Enhanced bonding of low melt temperature alloys to tubing, casing, and even non-metallic material surfaces may be achieved through the application of ultrasonic energy. High frequency ultrasonic waves may clean and prepare substrates for bonding by ablating oxides and scales from the surfaces. Frequencies in the range of 10-60 kHz will efficiently transfer through the well fluids to the surrounding material and cavitate the fluids to remove oxide layers. The downhole environment is relatively free of oxygen, so reoxidation is minimized and bonding agents such as flux may not be required to bond the alloy to the tubing.

Ultrasonic soldering may also be used to facilitate bonding of the molten alloys to non-metallic surfaces such as ceramics, glass, and rock. The alloy may be an active solder. The active solder may not require a bonding agent to adhere to steel pipe, or non-metallic materials such as cement, rock, or other downhole materials or structures. The vibration and cavitation in the molten solder permits active solders to wet and adhere to non-metallic surfaces.

Sound energy may be applied by any appropriate method, for example, sound energy may be provided by vibrating a structure or tubing, such as casing, from the surface, vibrating a separate tool module in the deployment string, or from a self-powered vibration module coupled to an exothermic heater, such as a thermite heater. The separate tool module may be powered from surface via an electric cable or may be powered by batteries. The self-powered module may be powered by a heater module, deriving the module's energy from the high temperature reaction with a thermoelectric or similar direct energy conversion device. Electrical power sources may be utilised to drive a piezoelectric or mechanical generator, producing sound waves of the desired amplitude and frequency.

The ultrasonic vibrations may be transmitted into the molten alloy from piezoelectric crystals mounted on a downhole tool. Alternatively, the vibrations may be transmitted into a steel well casing or adjacent rock from the downhole tool via contacting arms, such as retainer slips. In another embodiment the vibrations may be transmitted via extendable or expanding retractable arms, petals or rings that are translated axially through the molten alloy and directly contact the surface that the alloy is intended to bond to.

The plug or barrier-forming material may be provided in a form to facilitate delivery into a bore, heating in the bore, and distribution in the bore.

The plug or barrier-forming material, or components of the material, may be in powder form and may be compacted into tablet or bead form.

The tablets or beads may be coated to, for example, limit or prevent wetting of the material by downhole fluids, or to facilitate bonding with downhole materials. For example, one or both of the first metal and a flux may be provided with an epoxy coating to facilitate bonding with rock, shale, or mudstone. Components of the material, for example flux, may be provided in tablet, coated tablet, or capsule form. The components may be adapted to facilitate maintaining an even distribution of components, for example a weighted flux may be provided in combination with alloy beads.

The plug or barrier-forming material may be delivered into a bore by any appropriate mechanism, for example within a suitable container, which may comprise an atmospheric chamber, or a pressure-balanced chamber. The chamber may be coated internally to limit or prevent premature spoiling of flux material within the chamber.

The material may be heated in a downhole location. Alternatively, or in addition, the material may be heated on surface and the heated material supplied to a downhole location. Downhole bores are typically filled with liquid and the fluid will be heated by the heated material and will be heated by any heaters used to heat the material downhole. Heating of the well bore fluid may create convection currents, inducing fluid movement in the bore. Components of the material, or other materials that are provided or present at the downhole location, may become entrained in or by such convection currents and carried away from the intended location. For example, flux supplied to the bonding location may be soluble in the bore fluid and the concentration of flux at the bonding location may be reduced such that the flux is rendered less effective. For example, convection currents may act to dilute supplied flux to a level below 50 mg flux per litre of alloy. Preventing or limiting the dilution of the flux may be desired to facilitate formation of a secure bond between the alloy and neighbouring material. For example, it may be difficult to maintain a preferred flux concentration when depositing alloy at the bonding location in bead or shot form, accompanied by tableted flux or flux capsules. Accordingly, aspects of the disclosure relate to methods and apparatus for restricting or suppressing convention currents at a downhole bonding location. This may involve locating or providing a barrier in the bore. The barrier may be a deflector or member provided on a downhole tool or deployed in the bore. In other examples a convection current-restricting material may be deposited in the bore, typically above the plug or barrier-forming material. For example, depositing a low porosity or low permeability layer of material, such as a fine grain silica sand, above alloy beads or shot provided in combination with tableted flux or flux capsules, may contain or supress the convection currents sufficiently to ensure a preferred concentration of flux is maintained in close proximity to the alloy as the alloy is heated and becomes molten. The convection current-restricting material may be delivered into the bore separately, or together with the barrier-forming material, for example both materials may be deployed in a sleeve or dump bailer and released into the bore such that the convection current-restriction material is deposited above the barrier-forming material. Any appropriate volume or mass of convection current-restricting material may be provided, for example a volume of sand may be delivered into the bore to form a 10-50 cm deep cylindrical layer on top of the barrier-forming material.

A plug or barrier comprising the first metal, with or without particulates, fibres, or aggregates, may be backed up, topped, or reinforced with a mechanical structure which is secured to a surrounding tubing or casing. Such a structure may comprise a mechanical bridge plug, cement, or a thermite plug. A thermite plug formed of thermite reaction products may provide significant strength (as much as 25,000 psi compressive strength compared to <5000 psi strength for common well cement), be corrosion resistant, and provide a good mechanical bond to the tubing. The traditional aluminothermite reaction produces aluminium oxide and iron, with reaction temperatures over 2500° C. The aluminium oxide ceramic product solidifies at 2100° C. The thermite reactants may be modified with minerals and oxides to produce a feldspar product (such as anorthite) in place of pure aluminium oxide. This serves to suppress the solidification temperature, causing the thermite reaction products to solidify at temperatures as low as 1400° C. Thus, thermite formulations which react at lower temperatures may be provided to form ceramic plugs which can contact and fill the wellbore prior to freezing. Such ceramic plugs may provide high compressive strength, corrosion resistance, high bond strength anchors to back up alloy plugs and mitigate creep effects in the alloy plug structure. For example, an anorthite top layer above an alloy plug may provide a high shear bond strength against wellbore rock or steel bore liners. The thermite may be deployed into the bore using any appropriate method and may, for example, be deployed in a hermetically sealed container on a wire or pipe.

The plug or barrier-forming material may be provided in combination with a heater. The heater may take any appropriate form and may be adapted to be removed from the bore following heating of the material or may remain in the bore. The heater may have a tapered form to facilitate removal.

The heater may be an electric heater, or may be an exothermic reaction heater, such as a thermite heater.

Other aspects of the disclosure relate to a method comprising:
depositing a low permeability material above a plug or barrier-forming material in a bore; and
heating and melting the plug or barrier-forming material.

The plug or barrier-forming material may be an alloy.

The plug or barrier-forming material may be in the form of beads or shot.

The plug or barrier-forming material may be provided in combination with flux.

At least one of the plug-forming material, flux and low permeability material may be deposited from a carrier, a tube, a dump-bailer, or the like, to an area adjacent to a heater.

The low permeability material may be a layer of sand or other granular material, and in one example is a 10-50 cm thick layer of silica sand. In other examples the low permeability layer may comprise steel sand or fine steel grit.

The source of heat for heating and melting the material may be exothermic, or the heat source may be electric.

The heat source may be withdrawn before the barrier-forming material has solidified.

Aspects of the disclosure also relate to a plug or barrier-forming material for use in downhole tubing, the material comprising a non-eutectic alloy in combination with coated aggregate and flux, whereby the coated aggregate adheres to the alloy and the alloy adheres to the downhole tubing.

The alloy may be provided in combination with materials intended to reduce or minimise alloy creep and ageing.

The barrier-forming material may be provided in combination with an exothermic heater, whereby a reaction product resulting from activation of the heater forms one or more layers above the plug or barrier. The exothermic heater may be a thermite heater. The reaction product may be a ceramic material. The exothermic heater may include materials for modifying the reaction temperature generated by the heater, or materials which modify the solidification temperatures of the reaction products. In one example a thermite heater may be provided which generates anorthite as a modified reaction product, and the anorthite may form a top layer on a plug or barrier.

In another aspect the disclosure relates to a plug or barrier-forming material comprising a mixture of alloy particles and a bonding agent such as flux powder. The material may optionally include particulate or fibrous material such as aggregate.

The alloy may take any appropriate form, such as powder, chips, or granules. The alloy may have a particle size between 0.05 and 1.0 mm.

In one example the alloy and flux may be blended then compacted and may be provided in tablet or bead form. The tablets or beads may be deposited around heaters that have been deployed inside tubing. The tablets or beads may be deposited into an annulus; a heater may be deployed into the tubing forming the inner wall of the annulus.

In other examples the alloy and flux, and optionally an aggregate, may be blended and compacted into a cylindrical or hollow cylinder form. A thick or thin-walled cylindrical form may be adapted for location around a heat source or may be deployed around or internally of tubing. The cylindrical form may be in several parts, for example a clam shell, to facilitate location and assembly. The parts may be clamped or otherwise secured. Alternatively, a heat source may be located around a cylindrical alloy/flux form. The cylindrical forms may be adapted to be stacked, for example compacted alloy and flux could be provided as short toroidal sections for stacking when assembled with a heat source.

Cylindrical forms of the alloy and flux compact may be deployed around heaters into downhole tubing to form patches, straddles, or plugs. Cylindrical forms of the alloy and the flux may be deployed around unperforated tubing or casing to create packers, with a heater deployed inside the tubing/casing.

The heat source may take any appropriate form, for example exothermic or electric.

The alloy and flux may be subject to blending and powder compaction. This process offers numerous advantages when compared to casting. The alloy and flux are in intimate contact when emplaced, facilitating bonding, and minimising the amount of flux material required. A relatively small amount of energy is required to create the alloy/flux forms and the process is suited for batch/bulk/mass production.

A coating may be applied to the compacted alloy/flux form to, for example, limit or prevent premature leaching of the flux. The coating may be a material that is impervious to well fluids but breaks down with heat or fluid contact. The coating may be metallic, polymeric, ceramic or another material. The coating may be applied with plasma spray, electrolytic, or other suitable means. In one example the powder compacted flux/alloy form is coated with alloy.

The compacted forms may be sintered to achieve preferred mechanical or permeability properties.

The downhole tubing or other structures may be surface coated (internally and/or externally), pre-treated, coated, or otherwise modified to aid bonding. The coating may be copper, or another metal such as zinc, tin, or the like. Where a tin-based alloy is used to form the barrier then a metallurgical bond with the adjacent tin-coated tubing/casing (internally and/or externally, as appropriate) could be achieved without the need for flux. The alkaline stannate tin plating process may be preferably used on the adjacent tubing/casing surfaces in alloy casing packer applications. The coating may be thermally applied by various methods or alternatively be a paste or other liquid flux material to enhance heat transfer and facilitate bonding.

The provision of downhole structures adapted to aid bonding with a plug or barrier-forming material forms another aspect of the disclosure. The downhole structures may be located in a bore in an earlier operation, for example the provision of coated casing during the initial lining of a drilled bore, or the provision of coating tubing placed within existing tubing, in which situation tubing with an external coating may be placed within casing with an internal coating. The downhole structures may be slick/monobore or have profiles machined or applied to the internal or external surfaces adjacent to where the alloy barrier will be formed. Alternatively, or in addition, coated downhole structures may be located in the bore before or during the process of forming the plug or barrier, for example the structure may be a tin-coated retainer that is run into the bore with a plug-forming tool and becomes part of the plug.

Aspects of the disclosure also relate to the use of active solder alloys in forming a barrier or seal downhole.

The active solder alloy may comprise <10% of active elements such as indium, titanium, hafnium, zirconium, and rare earth elements such as cerium, lanthanum, and lutetium.

Aspects of the disclosure also relate to mechanically agitating an interface between a molten active solder alloy and an adjacent surface.

The mechanical agitation may be achieved using mechanical fingers such as calliper fingers; a mechanical disc such as an inverted petal style retainer; a mechanical bow spring type device; or a retractable device comprising fingers, a disc, or a bow spring type device expandable from a base of a heater to contact the surface.

Material may also be provided within the alloy which facilitates agitation of the interface as an object, such as a heater, is moved through the alloy. The material may be an aggregate, for example a steel aggregate. Movement of the aggregate may be provided by retrieving a heater from or through the molten alloy.

Aspects of the disclosure also relate use of ultrasonic soldering in a downhole environment.

Power for the ultrasonic soldering may be delivered from surface; provided by a battery located downhole; provided by a thermionic or thermoelectric generator.

A bonding method may comprise powering piezoelectric crystals to generate vibrations to deoxidise surfaces.

A bonding method may comprise melting alloy in the presence of a powered piezoelectric crystal.

An alloy to steel bonding method may comprise providing active elements in the alloy such as indium, titanium, hafnium, zirconium, and rare earth elements such as cerium, lanthanum, and lutetium to facilitate bonding to enhance bonding to steel.

An alloy to non-metallic bonding method may comprise providing active elements in the alloy such as indium, titanium, hafnium, zirconium, and rare earth elements such as cerium, lanthanum, and lutetium to facilitate bonding to non-metallic surfaces such as rock.

An aspect of the disclosure relates to providing active elements such as indium, titanium, hafnium, zirconium, and rare earth elements such as cerium, lanthanum, and lutetium in an alloy for deployment in a well borehole.

The active and rare earth elements may facilitate bonding of the alloy to downhole materials or structures, such as steel and non-metallic wellbore elements.

Aspects of the disclosure relate to an alloy plug or barrier-forming system provided with a combination of aggregate and ultrasonic soldering; a combination of aggregate and an active solder; and a combination of aggregate, ultrasonic soldering, and an active solder.

These aspects may be provided in combination with means to prevent the alloy from moving/creeping. For example, a layer or platform of a thermite reaction product, such as anorthite, may be provided below the alloy, for example in tubing, an annulus, or an outer annulus, or a layer or platform of thermite reaction product may be provided above the alloy.

In further aspects of the disclosure, acid may be utilised to prepare the surface of downhole tubing, such as steel casing, to facilitate bonding. Any appropriate acid may be utilised, such as hydrochloric acid. The acid may be provided in gas or liquid form, although gas may be preferred as the gas does not require neutralisation after application.

Acid, or an acid-generating tool, may be deployed in the bore in advance of the alloy or as part of an alloy deployment tool string. For example, an acid-generating tool may be placed below an alloy retainer and react prior to the retainer setting or the alloy being melted proximate to the casing surfaces.

For use in forming a tubing plug an acid-generating tool may be deployed in the tubing. For use in forming an annulus barrier holes or perforations may be formed in the tubing to allow the acid to bleed into the annulus.

A tool that may be employed to generate hydrochloric acid gas downhole is described in WO2021007645A1, the disclosure of which is incorporated herein in its entirety.

According to an example of the disclosure there is provided a plug or barrier-forming material comprising: a matrix of a first metal and an aggregate of uniform or irregular shaped macroscopic objects, the aggregate being coated with a second metal to facilitate bonding to the first metal.

According to a further example of the disclosure there is provided a method of forming a downhole plug or barrier, the method comprising:
providing plug or barrier-forming material comprising a first metal and an aggregate of uniform or irregular shaped macroscopic objects coated with a second metal to facilitate bonding to the first metal;
deploying the material in a bore;
providing heat energy to heat the material and fluidise the first metal;
allowing the fluidised first metal to cool in the bore and form a composite plug or barrier comprising the first metal and the aggregate.

According to another example of the disclosure there is provided a plug or barrier-forming material comprising a mixture of alloy particles and a bonding agent such as flux powder.

According to a still further example of the disclosure there is provided a downhole method of bonding an alloy to a non-metallic surface comprising providing active elements in the alloy to facilitate bonding the alloy to the non-metallic surface.

According to another example of the disclosure there is provided a downhole structure having a surface coated with a metal to facilitate bonding with an alloy-based plug or barrier-forming material.

According to a yet further example of the disclosure there is provided a method of forming an alloy barrier in downhole tubing comprising cleaning an internal or external surface with hydrochloric or hydrofluoric acid gas to aid the subsequent bonding of the alloy to the tubing.

The skilled person will appreciate that the various features of the aspects described above and as recited in the claims below may be combined as appropriate, and that the various features may also have individual utility, separately of the other aspects and features.

### BRIEF DESCRIPTION OF THE DRAWINGS

These and other aspects of the drawings will now be described, by way of example only, with reference to the accompanying drawings, in which:

FIG. 1 is a schematic of a deployment sleeve of apparatus made in accordance with an example of an aspect of the present disclosure;

FIG. 2 is a schematic of a step in a plug-forming method utilising the deployment sleeve of FIG. 1;

FIG. 3 is a schematic sectional view of an alloy ball of a plug-forming material of an example of an aspect of the present disclosure;

FIGS. 4 to 13 are schematics of alternative plug and barrier-forming materials;

FIG. 14 is a schematic of an alternative form of plug in a casing;

FIGS. 15 to 22 are schematics illustrating aspects of the present disclosure in which active soldering techniques are utilised to facilitate bonding of alloy to downhole tubing;

FIGS. 23 and 24 are schematics illustrating the effects of providing active alloy and vibrations at an interface between a molten alloy and a substrate, and

FIG. 25 is a schematic of an alternative barrier-forming method.

### DETAILED DESCRIPTION OF THE DRAWINGS

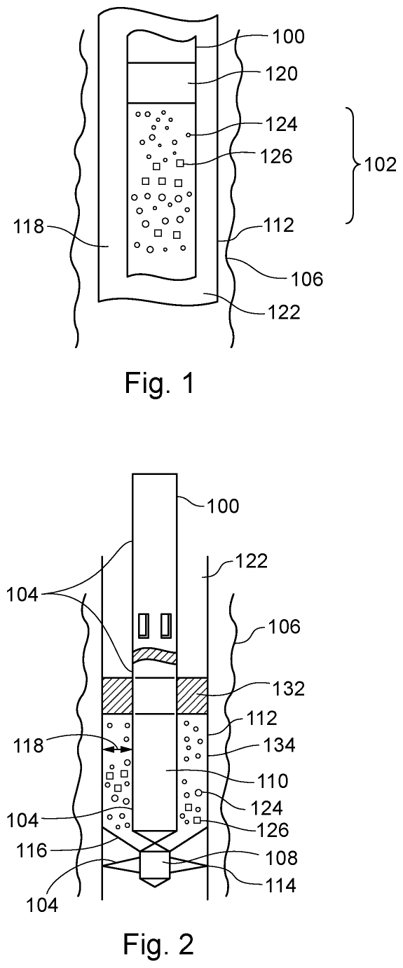

Reference is first made to FIGS. 1 and 2 of the drawings, FIG. 1 being a schematic of deployment sleeve 100 of apparatus made in accordance with an example of an aspect of the present disclosure, and FIG. 2 being a schematic of a step in a plug-forming method utilising the deployment sleeve 100 of FIG. 1. The sleeve 100 and other elements of the apparatus as will be described below, are provided in combination with apparatus such as described in applicants earlier patent applications, for example WO2020/144091, WO2020/216475, WO2021/043443, WO2021/043444, WO2022/096149 and GB2586796, the disclosures of which are incorporated herein in their entirety.

The sleeve 100 initially contains a volume of plug-forming material 102 and is incorporated in apparatus 104 intended to be run into a wellbore 106 on an elongate support, such as a wireline. The apparatus also comprises a retainer device 108 and a thermite heater 110. The apparatus 104 has a generally cylindrical elongate form with the retainer device 108 at the lower or leading end of the apparatus, and the heater 110 positioned between the retainer device 108 and the sleeve 100.

The apparatus 104 is intended to be run into a bore-lining tubing, such as a casing 112. At an appropriate sealing location in the casing 112, the heater 110 is activated. As described in our earlier patent applications, activation of the heater 110 causes slips 114 and retainer discs/petals 116 on the retainer device 108 to extend and engage the wall of the casing 112. The sleeve 100 is subsequently opened allowing the plug-forming material 102 to flow out of the lower end of the sleeve 100 and into an annulus 118 between the heater 110 and the casing 112. As will be described, the sleeve 100 also contains a volume of silica sand 120, and this is deposited on top of the plug-forming material 102.

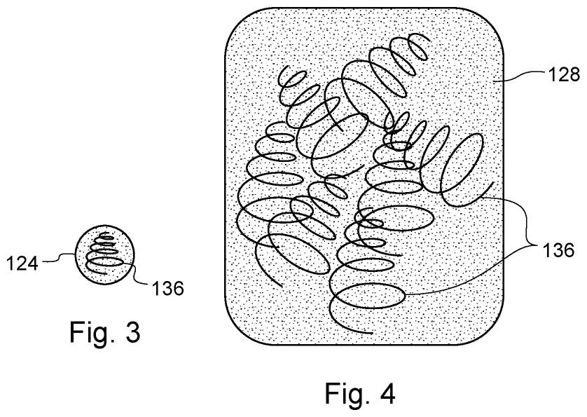

The plug-forming material 102 is relatively dense and once heated and melted by the heater 110 displaces the well fluid 122 and flows to fill the annulus 118 between the heater 110 and the casing 112. The heater 110 may be retrieved from the molten material 102 or may remain in the casing 112 and become an integral part of the resulting casing-sealing plug. The plug-forming material 102 comprises alloy beads 124 and flux tablets or capsules 126. As will be described below, with reference to FIGS. 3 to 13, which illustrate different bead forms and compositions, the alloy beads 124 may comprise an alloy 128 which melts and forms a plug matrix 130 and one or more of: particulate material; fibrous material, or an aggregate of uniform or irregular shaped macroscopic objects.

The initial activation of the thermite heater 110 melts or softens internal retainers which then releases compressed springs to extend the retainer disc/petals 116 and the slips 114 to engage the casing 112. The apparatus 104 is thus now supported in the casing 112. Subsequent activation of the heater 110 severs a coupling between the heater 110 and the sleeve 100, allowing the sleeve 100 to be separated from the heater 110, and the alloy beads 124 and flux tablets 126 to flow out of the open lower end of the sleeve 100 and fill the annulus 118 between the heater 110 and the casing 112. The extended retainer disc 116 prevents the beads 124 and tablets 126 from falling into the lower part of the casing 112. The alloy and flux may still be in the form of beads 124 and tablets 126 on flowing from the sleeve 110, or at least some of the alloy and flux may have been fluidised by the heater 110 while still retained within the sleeve 100.

The sand 120 will flow out of the sleeve 100 following the alloy beads 124 and flux tablets 126 and will form a low permeability layer 132 in the annulus 118 on top of the alloy and flux. The sand layer 132 displaces well fluid 122 that would otherwise occupy the volume directly above the alloy and flux and substantively restricts movement of the well fluid 122 in this volume. The sand layer 132 thus provides a number of advantages. In addition to segregating the volume of well fluid 122 from and the volume of well fluid directly adjacent the heater 110 and the beads 124 and tablets 126, the sand layer 132 also restricts the convection currents that would otherwise have been induced in the well fluid 122 adjacent the melting alloy and flux by the high temperatures created by the heater 110. Thus, any dilution of the flux by the well fluid is minimised, such that the concentration of flux at the bonding location 134 may be maintained at an effective level. Also, energy loss from the bonding location 134 due to convection currents in the well fluid 122 is very significantly reduced, such that a greater proportion of heat energy generated by the heater 110 is retained at the bonding location 134. This will minimise the possibility of incomplete melting of the alloy and will result in the casing 112 being heated to a higher temperature, improving the quality of the alloy to casing bond.

In other examples the plug-forming material may be initially provided in a form that does not flow, for example as a compacted, sintered or cast cylinder for location around the heater 110, occupying the annulus 118 between the heater 110 and the casing 112; of course, sufficient clearance is provided to permit the cast material to be run into the casing 112. In such an operation the material may incorporate a low density, low thermal conductivity aggregate which reduces the thermal conductivity of the plug forming composite material, resulting in higher composite temperatures during the melting phase in the deployment. After the heating/melting phase, the alloy separates from the lower density aggregate and the aggregate floats on top of the alloy.

Suitable low density insulating aggregates include metal oxides such as aluminium oxide granules or spheres, with thermal conductivity of 28 to 35 W/m-K (about half that of steel) and a density of 3.95 kg/m3, or silicon dioxide with a much lower conductivity of 1.7 W/m-K and a density of 2.6 kg/m3. If an increase in composite temperature is desired by using this mechanism, a suitable thermal conductivity for the aggregate is between 1.7 and 30 W/m-K. Other oxides of zinc, magnesium, manganese, or any other oxide form which is of suitable thermal, mechanical, and chemical properties may be utilised. Other ceramics, such as metal nitrides and carbides as well as composite fired ceramics may be beneficially utilised, depending on the thermal/physical properties desired.

Such low thermal conductivity aggregate, when combined with the alloy metal, forms a composite with a lower bulk thermal conductivity than that of the pure metal aggregate. Composite thermal conductivity is estimated knowing the fraction of composite volume occupied by the lower conductivity aggregate using a simple volume weighting method. If half the volume of the composite is occupied by the aggregate, then an aggregate with half the thermal conductivity will reduce the bulk thermal conductivity of the composite by as much as 25%. The composite volume is preferably packed to the highest density of aggregate, the spherical case being cubic closest packing with a bulk porosity of 47%. Aggregate with irregular shape and size can result in porosities as low as 35%.

The reduced thermal conductivity of the composite acts as an insulator (compared to a metallic aggregate) and results in higher temperatures with a given heater output, improving the barrier setting and bonding performance and reducing the risk of molten alloy prematurely freezing before the molten pool has formed.

The composition of the alloy beads 124 used to form the plug matrix 130 may be selected to provide desired physical and chemical attributes, and a first example is illustrated in FIGS. 3 and 4, with FIG. 3 being a schematic sectional view of an alloy bead or ball 124 of a plug-forming material, and FIG. 4 being a schematic sectional view of part of the alloy plug formed from a number of such balls. In this example, each alloy ball 124 contains a compressed conical spring 136 which has been cast within the ball 124. When a volume of such balls 124 are melted, the molten alloy will flow to form a continuous mass and the springs 136, formed of spring steel, will extend and interlock with the springs 136 that were encased in adjacent balls, as illustrated in FIG. 4. When the mass of alloy 128 cools and solidifies, the springs 136 will be locked in the extended and interlocked configuration, thus reinforcing the alloy 128. The composition of the flux provided with the material will have been selected to facilitate bonding between the springs 136 and the alloy 128, and also between the alloy 128 and the casing 112.

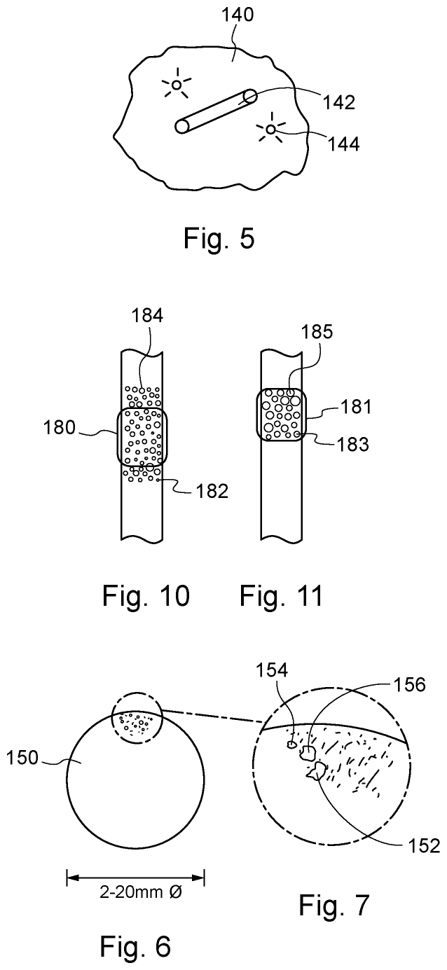

FIG. 5 illustrates an alternative composition, in which an alloy matrix 140 is reinforced with nanotubes 142 and nanoparticles 144. The particulate material may comprise micro or nano particles of metallic, intermetallic, or ceramic material. The nanotubes 142 and nanoparticles 144 impede grain growth and reduce creep in the alloy matrix 140 and the nanotubes 142 also act as structural reinforcement.

FIGS. 6 and 7 illustrate compacted alloy spheres 150, which may have a diameter of between 1.6 and 20 mm, formed of irregular alloy particles 152, flux particles 154, and a binding agent/lubricant 156.

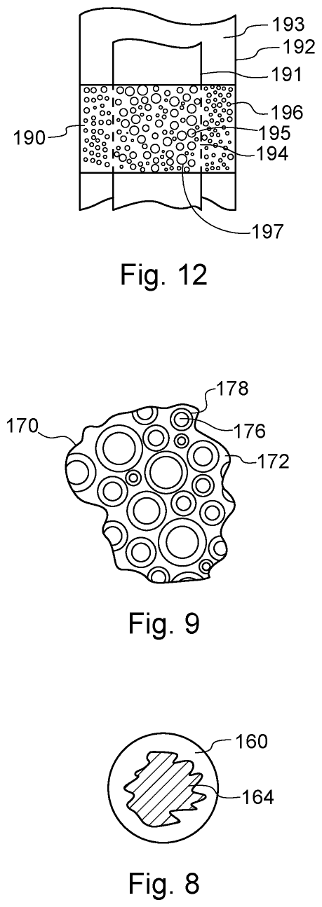

FIG. 8 illustrates an alloy bead 160 comprising an alloy matrix 162 surrounding an irregular aggregate 164. The aggregate 164 provides aggregate reinforcement to the matrix 162.

FIG. 9 illustrates a section of a plug 170 formed of an alloy matrix 172 in which are dispersed beads or balls 174 comprising a metal or ceramic aggregate core 176 with a coating 178 to facilitate bonding with the alloy 172.

In general, the preferred density of metal aggregates used to form the beads or balls 174 (and similarly, if the aggregates are provided in different forms) is near to or greater than the density of the molten alloy, to facilitate immersion of the aggregate particles in the alloy. Steel aggregate is suitable for these composite materials and has a density (approximately 8 kg/m3 depending on the specific steel) near that of most low melt temperature alloys. Also, the elastic modulus of steel (210 GPa) is high enough to significantly stiffen composites of low melt temperature alloys, which have moduli typically below 5 GPa. Steel is readily available in many alloys, can be hardened or softened, and is readily plated with materials, such as copper or tin, to enhance bonding to the alloy.

Alternatively, high density metals such as tungsten and molybdenum, as well as their carbide and nitride forms, have higher density than most alloys and will readily settle in molten alloy. These materials can also have very high hardness which contributes to the stiffness of the plug. Stiffening of the plug results in less deflection under compressive stress.

The composite material forming the plug 170 may have a low thermal coefficient of expansion when compared to the material of the tubular or other downhole substrate, for example the steel used to form the casing 112. In forming the plug 170, the aggregate 176, metal/alloy 172, and casing 112 may all be heated up to a uniform elevated temperature to fluidise the metal, then cool down to the ambient well temperature. The resulting temperature change can be on the order of 50 to 400° C. The aggregate 176 may be formed of low COE metals such as invar (a 36% nickel/64% iron by mass alloy), with a linear coefficient of expansion as low as 1e-6/° K as compared to the COE of steel of 10.8e-6/° K. This difference in COE produces the favourable condition of the settled and consolidated aggregate reducing in approximately 1/10^{th} in linear dimension compared to the surrounding steel tubing.

Such an aggregate 176 with very low thermal expansion has a unique benefit due to differential expansion/contraction by dissimilar metals. When the composite with such an aggregate 176 is cast inside a casing 112 to form a barrier, the casing 112, alloy 172, and aggregate 176 all equilibrate at a peak temperature before cooling and solidification occur. As the casing 112 and plug material cool to the solidification temperature of the alloy 172, the casing 112 shrinks slightly about the plug 170. This compacts the aggregate 176 into an interlocked and stiff structure, with the pore spaces filled by alloy 172. If the alloy 172 is an expanding alloy (such as bismuth-based alloys) the plug will also expand slightly inside the tubing 112. Further cooling to the initial well temperature may result in the temperature dropping by as much as 50° C. At this point the differential shrinkage of the tubing 112 and composite comes into play. The steel tubing 112, with a linear thermal coefficient of expansion of 11e-6/° C., will shrink in diameter by almost 0.1 mm. If the aggregate 176 is of a nickel/iron alloy such as invar, with a COE of 1.2e-6/° C., it will ‘shrink’ only 0.009 mm in diameter, effectively forming a constrained plug 170 in the tubing 112.

FIGS. 10 and 11 illustrate plugs 180, 181 comprising an alloy matrix 182, 183 and aggregate 184, 185. In FIG. 10 smaller aggregate 184 is provided in a relatively long plug 180, while in FIG. 11 larger aggregate 185 is provided in a shorter plug 181.

FIG. 12 illustrates a barrier 190 in a portion of bore with concentric casings 191, 192 and an annulus 193 between the casings 191, 192. The inner casing 191 is perforated 194. The barrier 190 comprises an alloy matrix 195 and a mix of smaller and larger aggregate 196, 197. The barrier-forming material will have been delivered into the casing 191 and fluidised, allowing the material to flow. The molten alloy will have flowed through the perforations 194 into the annulus 193, however only the smaller aggregate 196 is carried into the annulus 193. Alternatively, or in addition, the barrier-forming material may have been deployed in a flowable bead form, with the smaller aggregate 196 contained in smaller beads that may have flowed through the perforations 194 and into the annulus 193. Thus, once the alloy 195 has cooled and solidified the barrier has a different composition within the casing 191 and in the surrounding annulus 193.

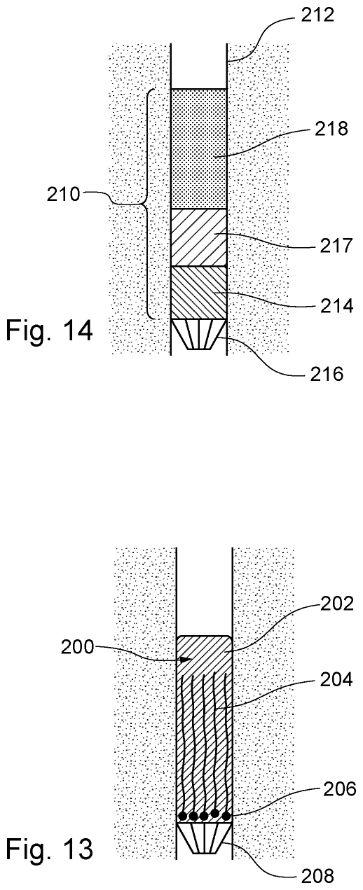

FIG. 13 illustrates a plug 200 comprising an alloy matrix 202 and metal fibres 204 which extend substantially axially through the matrix 202. The fibres 204 are attached at one end to anchor particles 206. While the fibres 204 have a density lower than the alloy 202, the particles 206 have a density higher than the alloy 202; in this example the fibres 204 are of ferroaluminium and the particles 206 are tungsten. Thus, when the alloy is molten the fibres 204 orient themselves as illustrated in FIG. 13, with the particles 206 resting on a retainer 208 provided at the lower end of the plug. Such oriented reinforcements increase the bulk shear strength of the barrier-forming matrix 202.

Reference is now made to FIG. 14 of the drawings, which illustrates an alternative form of plug 210 in a casing 212, in which the alloy portion of the plug is supplemented by external reinforcement. An alloy plug portion 214 has been formed directly above a retainer device 216. A thermite heater containing aluminium powder and iron oxide has been run into the casing 212 with or after the alloy 214 and has been activated to generate thermite reaction products in the form of iron 217 and a ceramic 218. The thermite reaction products 217, 218 bond to the casing 212 and resist displacement and creep of the alloy plug portion 214.

The thermite reaction products 217, 218 provide significant strength, the ceramic 218 is corrosion resistant, and both products provide a good mechanical bond to the casing 212. The thermite reactants may have been modified with minerals and oxides to produce a feldspar product (such as anorthite) in place of pure aluminium oxide. This serves to suppress the solidification temperature, with thermite reaction products solidifying at temperatures as low as 1400° C., and an anorthite top layer above an alloy plug 214 provides a high shear bond strength against the steel casing 212.

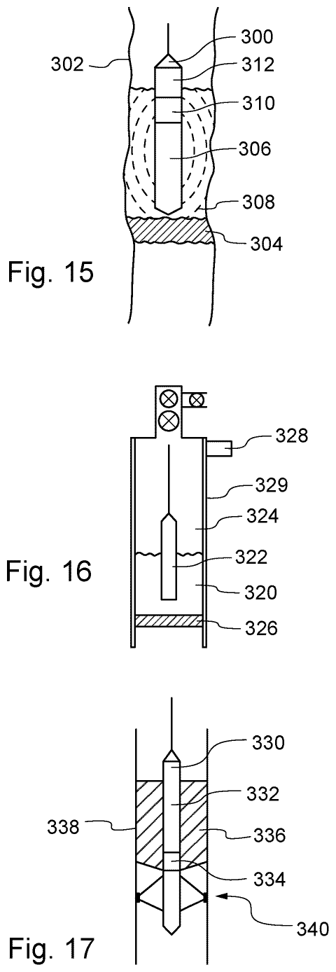

Reference will now be made to FIGS. 15 to 22 of the drawings, which illustrate examples of aspects of the present disclosure in which a variety of techniques are utilised to facilitate bonding of alloy to downhole bore walls. In these examples vibration or agitation is provided to improve the bonding of the molten alloy to the substrate material, which may be a downhole structure, such as casing or cement, or the rock or other material through which the borehole has been drilled.

FIG. 15 is a schematic of a downhole tool 300 located in an unlined bore 302 which has been provided with a mechanical or other packer or plug 304. A heater 306 has previously been activated to melt a volume of plug-forming material in the form of alloy 308. To facilitate bonding of the alloy 308 to the wall of the bore 302 a piezoelectric source 310, coupled to a power source 312, creates ultrasonic vibrations; the vibrations serve to deoxidise the surface of the bore 302. The tool 300 is retrieved from the alloy 308 before the alloy 308 has cooled and solidified.

The alloy 308 comprises active elements such as indium, titanium, hafnium, zirconium, and rare earth elements such as cerium, lanthanum, and lutetium. The active and rare earth elements facilitate bonding of the alloy 308 to the unlined bore walls, in combination with the agitation provided by the piezoelectric source 310.

In an alternative example at least a portion of the power for the source 310 is supplied from surface, via conductive wireline.

FIG. 16 is a schematic of an arrangement in which a volume of alloy 320 has been fluidised by a heater 322 in a casing-lined bore 324 above a plug or packer 326. A vibration device 328 is provided at surface and is coupled to the casing 329 such that operation of the device 328 vibrates the casing 329 and thus the interface between the molten alloy 320 and the casing 329.

FIG. 17 is a schematic in which a downhole tool 330 includes a heater 332 and a piezoelectric source 334 for generating vibration to facilitate bonding of the alloy 336 to the surrounding casing 338. In addition to transmitting vibration to the interface of the alloy 336 and the casing 338 via the external surface of the piezoelectric source 334 and the alloy 336, the tool 330 is mechanically coupled to the casing 338 by vibration-transmitting extendable arms 340.

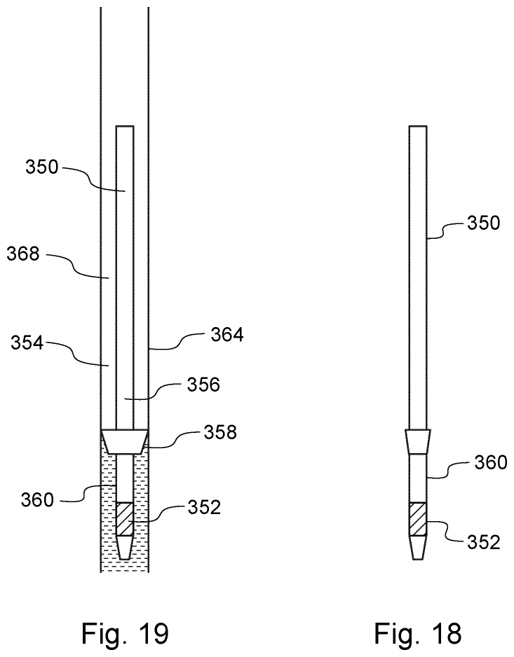

FIG. 18 is a schematic of a downhole tool 350 including a piezoelectric vibratory source 352 and FIG. 19 is a schematic showing the tool 350 creating a plug in a casing-lined bore 354. The tool 350 comprises a thermite heater 356 and an extendable retainer 358 located above a thermoelectric generator 360 and a piezoelectric vibratory source 362. The tool 350 will also initially be provided with a sleeve (not shown) containing alloy beads and located above the heater 356. Following activation of the heater 356, the retainer 358 is activated and extends into contact with the casing 364. The sleeve is then lifted clear of the heater 356 and the alloy beads fall from the sleeve and occupy an annulus 366 between the heater 356 and the casing 364. The activated heater 356 melts the beads to form a molten alloy annulus 368.

The upper end of the thermoelectric generator 360 is thermally coupled to the thermite heater 356 and the lower portion of the generator is located in the well fluid below the retainer 358. Thus, the upper end of the generator 360 will become hot through the action of the activated heater 356, while the lower end of the generator will remain relatively cool. This enables the generator 360 to produce an electrical current which is used to power oscillation circuitry and drive the piezoelectric vibratory source 362.

The vibratory source 362 generates 50 kHz vibration in the tool 350, which vibration is transmitted to the molten alloy 368 and the casing 364, enabling ultrasonic soldering of the alloy 368 to the surface of the steel casing 364.

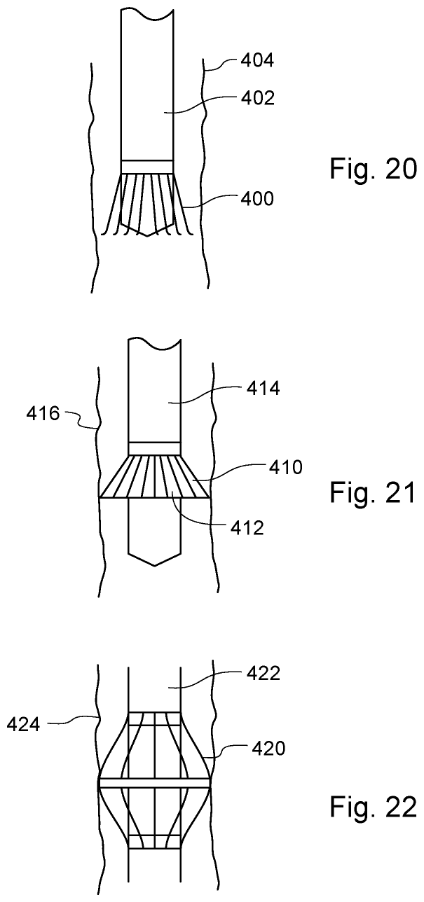

Reference is now made to FIGS. 20 to 22 of the drawings, schematics of alternative agitation arrangements for facilitating bonding of active alloys to a bore wall. In FIG. 20, mechanical agitation fingers 400 have been provided at the lower end of the body of a heater 402. The fingers 400 are sprung and are released from a restrained position when the heater is activated, to extend radially outwards and into contact with a surrounding bore or casing 404. Once a volume of alloy (not shown) has been melted between the heater 402 and the bore or casing 404, the heater 402 is retrieved, and in doing so the fingers 400 are pulled over the surface of the bore or casing 404, thus agitating the surface and facilitating bonding of the molten active alloy to the bore or casing 404.

In FIG. 21 an inverted discontinuous disc 410 formed of metal petals 412 is mounted in a heater 414. The petals 412 are released from a restrained position on activation of the heater 414, and on retrieval of the heater 414 the petals 412 mechanically agitate the surrounding bore or casing 416.

In FIG. 22 a bow-spring 420 is provided on a heater 422, on retrieval of the heater the bow-spring 420 mechanically agitating the surrounding bore or casing 424.

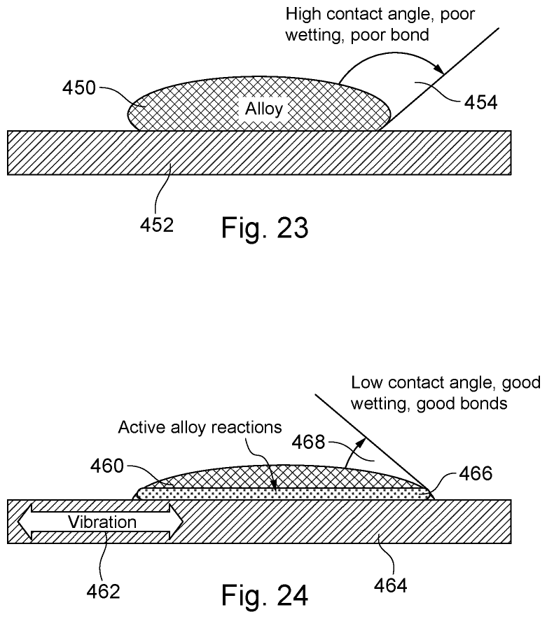

Reference is now made to FIGS. 23 and 24 of the drawings, which illustrate the effects of providing active alloy and vibrations at an interface between a molten alloy and a substrate. In FIG. 23 a mass of molten alloy 450 is shown on the substrate 452 with a large contact angle 454. This may have an adverse effect on the ability of the molten alloy 450 to wet the surface of the substrate 452 and to form an effective metallurgical bond. However, in FIG. 24 an active alloy 460 and agitation 462 of one or both of the alloy 460 and the substrate 464 result in active alloy reactions taking place at the alloy/substrate interface 466 to increase the interaction between the alloy 460 and the substrate 464, producing a small contact angle 468, good wetting, and resulting in a good bond.

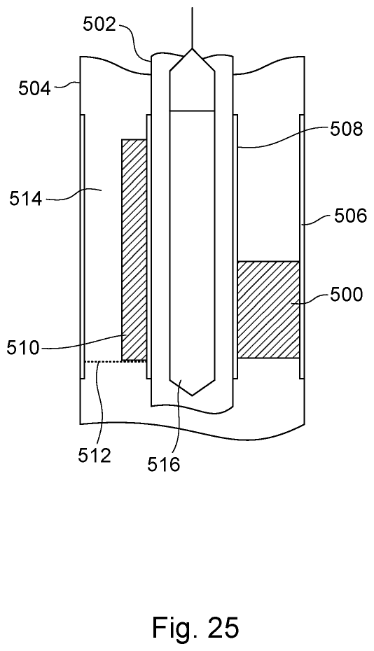

Reference is now also made to FIG. 25 of the drawings, a schematic of an alternative barrier-forming method. The left side of the drawing illustrates an initial step of the method, and the right side of the drawing illustrates the formed barrier, an annulus packer 500.

Downhole tubing 502 is provided within larger diameter casing 504. An internal surface of the casing 506 and an external surface of the tubing 508 have been coated using an alkaline stannate tin-plating process. A volume of barrier-forming material 510 is provided on the external surface of the tubing. The material 510 comprises a tin-based alloy in a cast or powder-compacted form. A retainer disc 512 is provided on the tubing 502 at the lower end of the material 510.

When the operator wishes to provide a packer in the annulus 514 between the tubing 502 and the casing 504, a heating tool 516 is run into the tubing 502 and positioned internally of the material 510. The heating tool 516 is activated and melts the material 510 which flows and extends across the annulus 514. The material 510 forms a metallurgical bond with the coated surfaces 506, 508.

It will be clear to the skilled person that the illustrated arrangements are merely exemplary of the aspects of the disclosure and that various modifications and improvements may be made thereto without departing from the scope of the present disclosure.

### REFERENCE NUMERALS

sleeve 100
plug-forming material 102
apparatus 104
wellbore 106
retainer device 108
thermite heater 110
casing 112
slips 114
retainer discs/petals 116
annulus 118
silica sand 120
well fluid 122
alloy beads 124
flux tablets/capsules 126
alloy 128
plug matrix 130
sand layer 132
bonding location 134
alloy matrix 140
nanotubes 142
nanoparticles 144
alloy spheres 150
irregular alloy particles 152
flux particles 154
binding agent/lubricant 156
alloy bead 160
alloy matrix 162
irregular aggregate 164
plug 170
alloy matrix 172
beads/balls 174
aggregate core 176
coating 178
plugs 180, 181
alloy matrix 182, 183
aggregate 184, 185
barrier 190
concentric casings 191, 192
annulus 193
perforations 194
alloy matrix 195
aggregate 196, 197
plug 200
alloy matrix 202
metal fibres 204
anchor particles 206
retainer 208
plug 210
casing 212
alloy plug portion 214
retainer device 216
iron 217
ceramic 218
unlined bore 302
packer 304
heater 306
alloy 308
piezoelectric source 310
power source 312
alloy 320
heater 322
casing-lined bore 324
packer 326
vibration device 328
casing 329
downhole tool 330
heater 332
piezoelectric source 334
alloy 336
casing 338
extendable arms 340
downhole tool 350
vibratory source 352
casing-lined bore 354
thermite heater 356
extendable retainer 358
thermoelectric generator 360
vibratory source 362
casing 364
annulus 366
molten alloy annulus 368
fingers 400
heater 402
casing 404
disc 410
petals 412
heater 414
casing 416
bow-spring 420
heater 422
casing 424
molten alloy 450
substrate 452
contact angle 454
active alloy 460
agitation 462
substrate 464
interface 466
contact angle 468
annulus packer 500
downhole tubing 502
casing 504
casing ID 506
tubing OD 508
barrier-forming material 510
retainer disc 512
annulus 514
heating tool 516

1-32. (canceled)

33: An apparatus for forming a downhole plug or barrier, the apparatus being deployable in a bore and comprising:
a plug or barrier-forming material comprising a volume of a first metal and an aggregate of uniform or irregular shaped macroscopic objects, the aggregate being coated with a second metal to facilitate bonding to the first metal; and
a heater operable to heat the material and fluidise the first metal,
whereby heating the material in a bore to fluidise the first metal and then allowing the fluidised first metal to cool and resolidify in the bore permits formation of a composite plug or barrier comprising a matrix of the first metal and the aggregate.

34: The apparatus of claim 34, wherein the aggregate comprises steel.

35: The apparatus according to claim 33, wherein the second metal comprises at least one of zinc, tin, and copper.

36: The apparatus according to claim 33, wherein at least one of: the aggregate has a higher elastic modulus than the first metal, and the aggregate has a lower density and lower thermal conductivity than the first metal.

37: The apparatus according to claim 33, wherein at least one of: the aggregate has a larger dimension of 0.5 mm or more; the aggregate has a larger dimension of 1.0 mm or more, and the aggregate has a diameter between 1.5 and 20 mm.

38: The apparatus according to claim 33, wherein the material is deployable in at least one of: a flowable form, and a cast form.

39: The apparatus according to claim 33, wherein the material comprises compacted powder.

40: The apparatus according to claim 33, wherein at least one of: the aggregate is provided in a spherical form, and the aggregate has an irregular form and is coated with another material to provide a smooth surface.

41: The apparatus according to claim 33, wherein at least one of: the apparatus comprises a bonding agent, such as flux.

42: The apparatus according to claim 33, wherein the plug or barrier-forming material comprises a mixture of alloy particles and a bonding agent such as flux powder.

43: The apparatus according to claim 33, wherein the plug or barrier-forming material is alloy-based, in combination with a downhole structure having a surface coated with a metal to facilitate bonding with the alloy-based plug or barrier-forming material.

44: The apparatus of claim 43, wherein the surface is coated with tin and the alloy is a tin-based alloy.

45: A method of forming a downhole plug or barrier, the method comprising:
providing plug or barrier-forming material comprising a first metal and an aggregate of uniform or irregular shaped macroscopic objects coated with a second metal to facilitate bonding to the first metal;
deploying the material in a bore;
providing heat energy to heat the material and fluidise the first metal;
allowing the fluidised first metal to cool in the bore and form a composite plug or barrier comprising the first metal and the aggregate.

46: The method of claim 45, further comprising forming the plug or barrier in a downhole structure and selecting the aggregate to have a lower thermal coefficient of expansion than the downhole structure.

47: The method according to claim 45, further comprising selecting an aggregate having a lower density than the first metal to reduce the thermal conductivity of the material.

48: The method according to claim 45, wherein the first metal comprises an alloy and further comprising bonding the alloy to a downhole non-metallic surface comprising providing active elements in the alloy to facilitate bonding the alloy to the non-metallic surface.

49: The method of claim 45, wherein the plug or barrier-forming material comprises an alloy and downhole tubing is provided in the bore, and further comprising cleaning a surface of the tubing with hydrochloric or hydrofluoric acid gas to aid the subsequent bonding of the alloy to the tubing.

50: The method of claim 49, wherein the downhole tubing is formed of steel.

51: The method of claim 49, further comprising directing the acid gas though tubing perforations into a tubing annulus to clean surfaces of the annulus.

52: The method according to claim 49, further comprising cleaning the surface of the tubing and forming an alloy barrier in the tubing in a single run.
